(19) United States
(12) Patent Application Publication
(10) Pub. No.: US 2006/0113505 A1
(43) Pub. Date: Jun. 1, 2006

(54) Scale inhibitor, composition useful for preparing same, and method of inhibiting scale

(75) Inventors: John L. Przybylinski, Missouri City, TX (US); Gordon T. Rivers, Houston, TX (US); Thomas H. Lopez, Stafford, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 11/247,755

(22) Filed: Oct. 11, 2005

Related U.S. Application Data
(60) Provisional application No. 60/620,209, filed on Oct. 19, 2004.

(51) Int. Cl. C02F 5/10

(52) U.S. Cl. 252/180

(57) ABSTRACT

An aminomethylene phosphonate having the general formula: 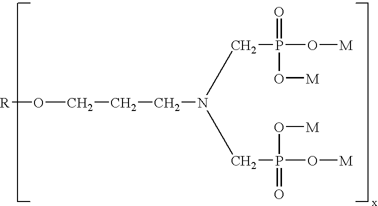 wherein x is an integer having a value of from 1 to 3, M is a hydrogen or a cation, and R is an atom or a hydrocarbyl having from 1 to 20 carbons can be used to inhibit scaling in applications such as cooling water treatments systems and oil wells.

### CROSS REFERENCE TO RELATED APPLICATIONS

This application claims priority to the U.S. Provisional Patent Application having Ser. No. 60/650,209 which was filed on Ser. No. 10/19/2004.

### BACKGROUND OF THE INVENTION

1. Field of the Invention

The present invention relates to a scale inhibitor. The present invention particularly relates to aminomethylene phosphonate scale inhibitors.

2. Background of the Art

The precipitation of minerals is a frequent problem in industrial activities wherein water having dissolved inorganic materials is transported or stored. For example, water may contain a variety of alkaline earth metal cations, such as calcium, barium and strontium, as well as anions such as bicarbonate, carbonate, sulfate, phosphate and silicate. When such ions are present in sufficient concentrations, they can form precipitates. Buildup of such precipitates on, for example, the inside surfaces of conduits not only obstructs fluid flow, but can also interfere with heat transfer across the surfaces, facilitate corrosion of the surfaces and harbor the growth of bacteria.

The obstruction of flow and the loss of heat transfer can be very undesirable. For example, in an oil well, it is often desirable to get the maximum flow from the well and the build up of inorganic precipitates can slow flow rates, or even block flow rates in narrow tubing. In industrial operations employing heat exchangers, the reduction in the rate that heat can transfer across a heat exchanger can cause a bottleneck in production process resulting in less production and can also increase fuel costs where heat exchangers are run at higher temperatures to make up for the poor exchanger efficiency. The build up of inorganic precipitates can also block sample taps and interfere with the operation of monitoring and control equipment.

### SUMMARY OF THE INVENTION

In one aspect, the present invention is a composition useful for inhibiting scale. The composition includes at least an aminomethylene phosphonate having the general formula: 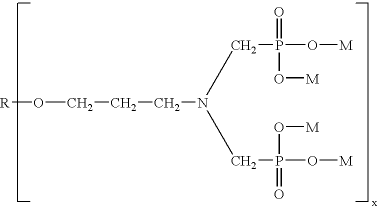
wherein x is an integer having a value of from 1 to 3, M is a hydrogen or a cation, and R is an atom or a hydrocarbyl having from 1 to 20 carbons.

In another aspect, the present invention is a method for inhibiting scale formation in a system including moving or static water and the water incorporating dissolved inorganic materials. The method includes a step of introducing into the system a scale inhibitor comprising an aminomethylene phosphonate having the general formula: 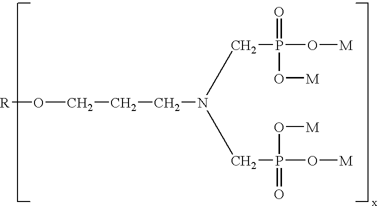
wherein x is an integer having a value of from 1 to 3, M is a hydrogen or a cation, and R is an atom or a hydrocarbyl having from 1 to 20 carbons.

In still another aspect, the present invention is a composition of matter wherein the composition of matter has is an aminomethylene phosphonate having the general formula: 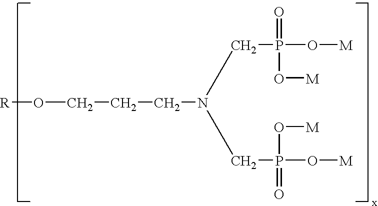
wherein x is an integer having a value of from 1 to 3, M is a hydrogen or a cation, and R is an atom or a hydrocarbyl having from 1 to 20 carbons.

### BRIEF DESCRIPTION OF THE DRAWINGS

For a detailed understanding and better appreciation of the present invention, reference should be made to the following detailed description of the invention and the preferred embodiments, taken in conjunction with the accompanying drawings, wherein:

FIG. 1 is a graph of the Calcite Culture Tube tests results from Example 1;

FIG. 2 is a graph of the Gypsum Culture Tube tests results from Example 1;

FIG. 3 is a graph of the Calcite Culture Tube tests results from Example 2; and

FIG. 4 is a graph of the Gypsum Culture Tube tests results from Example 2.

### DESCRIPTION OF THE PREFERRED EMBODIMENTS

Scale is the commonly used term for inorganic precipitates. Such precipitates include, but are not limited to, calcium carbonate, calcium sulfate, barium sulfate (barite), strontium sulfate and the like. One embodiment of the present invention is a scale inhibitor that may interact with an aqueous fluid to prevent or at least mitigate the precipitation of scales.

In one embodiment, the present invention is a composition useful for inhibiting scale. The scale inhibiting composition includes at least an aminomethylene phosphonate. The aminomethylene phosphonates of the present invention can be in either the acidic form or the salt form. For the purposes of the present invention, the term aminomethylene phosphonate, and in the plural, aminomethylene phosphonates, includes both the acidic and salt forms of the molecule.

The aminomethylene phosphonates useful in preparing the scale inhibitors have the general formula: 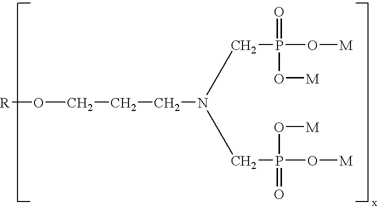
wherein x is an integer having a value of from 1 to 3, M is a hydrogen or a cation, and R is an atom or a hydrocarbyl having from 1 to 20 carbons. M may be the same or different and, when a cation, may be mono-valent, although it may also be poly-valent. For example, the cation can be potassium or sodium. The cation can be an ammonium ion, either substituted or unsubstituted, such as the substituted ammonium compound that would result from the neutralization of the acid form of the phosphonate with mono-ethanolamine. The cation can also be a higher valence cation when such cation does not interfere with the solubility of the aminomethylene phosphonate.

In the general formula of the aminomethylene phosphonates, R is an atom or a hydrocarbyl having from 1 to 20 carbons. The atom or hydrocarbyl will be one that can form a stable bond with an oxygen. Examples of such hydrocarbyls include: a methylene group wherein x will equal 2; an ethylene glycol moiety having a general formula —CH₂—CH₂— wherein x will equal 2; a propylene glycol moiety having a general formula —CH₂—CH₂—CH₂— wherein x will equal 2; a diethylene glycol moiety having a general formula —CH₂—CH₂—O—CH₂—CH₂— wherein x will equal 2; a cyclohexyl moiety having the general formula C₆H₈ or C₆H₇ wherein x will equal 2 or 3; an alkyl ester moiety having the general formula CH₃—(CH₂)ₙCO₂— wherein n is an integer from 1 to 18 and x will equal 1; and the like. The hydrocarbyls can also include other groups such as amine groups, ammonium groups, ester groups, and the like. Exemplary atoms that may be useful as R included hydrogen, N, and the like.

The scale inhibitors of the present invention will include at least one aminomethylene phosphonate but may be mixtures of aminomethylene phosphonates of the same general formula but differing in specifics. For example, in an embodiment, the scale inhibitor could be prepared wherein the R in the general formula is a dimethylene group in some molecules and a trimethylene in others. While both would have the same general formula, their specific formulas would be different from each other.

The aminomethylene phosphonates may be prepared by any method known to those of ordinary skill in the art of preparing such compounds to be useful. For example, the method of U.S. Pat. No. 4,931,189 to Dhawan, et al., the contents of which are incorporated herein by reference in its entirety, can be used by substituting the starting materials with those that can be used to form the aminomethylene phosphonates claimed herein. For example, an aminomethylene phosphonate which can be useful in preparing the scale inhibitor can be thus prepared by phosphonomethylation of an amine of the formula:
NH₂—CH₂—CH₂—CH₂—O—CH₂—CH₂—O—CH₂—CH₂—O—CH₂—CH₂—CH₂—NH₂
It is disclosed in this reference that the amine is added either in pure form or, if desired, as an aqueous solution, batchwise to a mixture of phosphorous acid and a second acid in a continuously stirred tank reactor, and the reaction mixture is heated to reflux, about 100° C. to about 120° C. It is further disclosed that this addition step is exothermic and cooling may actually be necessary. For nearly complete phosphonomethylation, that is, phosphonomethylation in excess of about 80%, at least about 3.2 to about 4 moles of phosphorous acid per mole amine should be employed and enough of the second acid to maintain acidic conditions in the reaction mixture.

In this same reference, it is disclosed that the second acid should be a strong mineral acid, such as hydrochloric acid, and enough should be present in the mixture to neutralize the amine. The process continues with an addition of formaldehyde in a molar amount at least about equal to the molar amount of the phosphorous acid, and preferably slightly greater, is added slowly to the reaction mixture and then the temperature of the mixture is then maintained for about two to about four hours.

The scale inhibitors are introduced into a moving or static body of water and admixed therewith. This admixing can occur through diffusion or stirring. In one embodiment, the scale inhibitor is supplied as aqueous solutions of scale inhibitor. Such solutions may be at any concentration, but may contain from about 10 to about 90 weight percent of the inhibitor. A solution containing from about 15 weight percent to about 70 weight percent is used in another embodiment. Where the scale inhibitors are to be used in low concentration, a dilute solution may be used as a master batch to facilitate correct dosing.

In an embodiment of the invention, an aqueous solutions of the scale inhibitor introduced into the feed line of a geothermal well, an oil well, a water flood well, or a cooling water system and is admixed by means of turbulence. In another embodiment, the scale inhibitor is introduced into a static body of water and spreads through the water by diffusion. The scale inhibitors can be introduced into the systems to be protected from scaling by any method known to be useful to those of ordinary skill in the art. In these or any other embodiment, the scale inhibitor is employed in a concentration sufficient to eliminate or reduce the precipitation of scale. For example in one embodiment, the scale inhibitor is employed in a concentration of from about 0.01 parts per million “ppm” to about 10,000 ppm. In another embodiment, the scale inhibitor can be employed in a concentration of from about 0.1 ppm to about 1,000 ppm. In still another embodiment, the scale inhibitor can be employed in a concentration of from about 1 ppm to about 100 ppm.

In addition to the polymer additives described above, the polyether polyamino methylene phosphonate compositions of the present invention can be used in further combination with yet other additives in limits that do not prevent the scale adhesion preventing effect of the agent and which may increase their effectiveness. Thus, it is possible, and often desirable, to use one or more steel, iron and/or copper corrosion inhibitors along with the polyether polyaminomethylene phosphonate scale inhibitor in order to obtain corrosion rates which are acceptable. Other additives that may be used with the scale inhibitor include, but are not limited to: foamers, defoamers, asphaltene and paraffin inhibitors, surfactants, and the like.

The aminomethylene phosphonates claimed herein have utility as scale inhibitors can be used in other applications. Other uses for these compounds include dispersants, corrosion inhibitors, and the like.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

Calcite and gypsum tests are run using a culture tube precipitation test procedure. Two non-scaling brine components are prepared. One component contains the scale forming anion and the other contains the scale forming cation. The amounts of salts used are given in Tables 1 through 4. Note that the mg/l in the tables is the concentration attained when the two components are mixed in a 1:1 ratio, not the concentration in the individual components.

The bicarbonate supplies a degree of buffering in the calcite test. Acetate is added to the gypsum test to supply similar buffering. The cation portion is essentially unbuffered and has negligible influence on the final pH of the mixture. The efficiencies of most aminomethylene phosphonate scale inhibitors are known to be weak functions of pH in the pH range 5.5 to 8.5. The formation of calcite scale is a strong function of pH. The calcite anion water as prepared is pH 8.1±0.1.

The inhibitors used in these examples are diluted, usually to 1% concentration, because the very small amounts required are difficult to add to the tests if full strength inhibitor is used. Aliquots of diluted inhibitors, less than 100 μl, are placed in screw cap culture tubes. Then 5.00 ml aliquots each of anion brine and cation brine are placed in each tube. The tubes are capped and placed in a water bath for two hours.

The calcite test is run slightly differently from the gypsum test. The calcite test is run at 160° F., and then the tubes are cooled. A 1.00 ml aliquot of supernate from each tube is diluted, made basic, and titrated with EDTA solution to a color change end point using Calver II indicator in order to determine the amount of calcium remaining in solution.

The gypsum test is run at 140° F., then the tubes are cooled and allowed to sit for another two hours in order to let additional precipitation proceed before they are titrated. A 200 μl aliquot of supernate from each tube is diluted, made basic, and titrated with EDTA solution to a color change end point using Calver II indicator in order to determine the amount of calcium remaining in solution.

For both types of tests a sample with no inhibitor is run along with the inhibited samples. The calcium level found in this “blank” sample is defines 0% protection. A sample of freshly mixed anion and cation solution is also titrated. The calcium level found in this sample defines 100% protection. The effectiveness of the inhibitor in each inhibited sample is calculated as a linear function of calcium concentration between the calcium levels representing the 0% and 100% points.

The products tested for scale inhibition properties are solutions of aminomethylene phosphonates. The concentrations of the phosphonates in the solutions depend on the method of preparation and the amount of neutralization and additional dilution. In order to accurately compare the inherent performance of the active ingredient, it is necessary to adjust the results for the “activity” of the preparation.

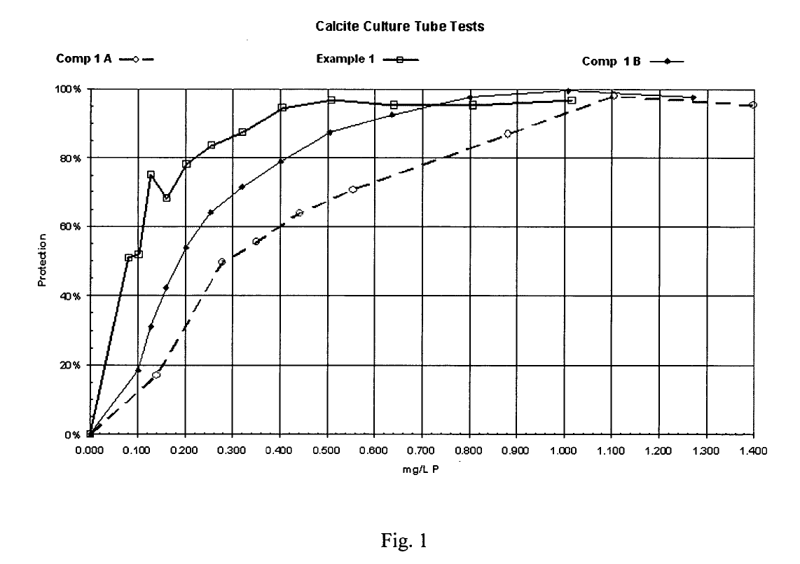

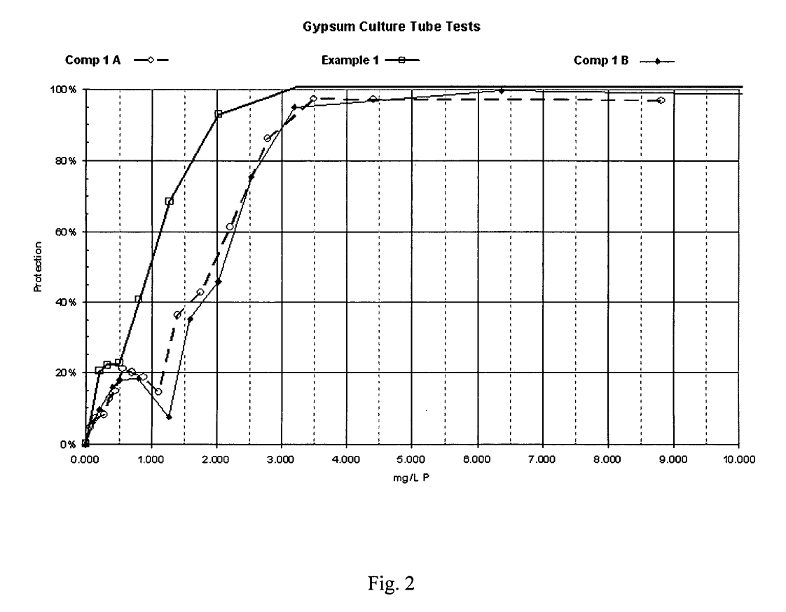

Activity can be defined in several different ways. In order to give a consistent and easily calculated basis to the comparisons, the plots below are shown in terms of mg/l phosphorus. This is valid in this case because all the compounds are aminomethylene phosphonates. The phosphorus level is easily calculated and is nearly the same proportion of the weight fraction of the molecule for these inhibitors. The test results are displayed in FIGS. 1 and 2.

Example 1 is an aminomethylene phosphonate prepared using an amine having the formula:
H₂NCH₂CH₂CH₂OCH₂CH₂OCH₂CH₂CH₂NH₂
It has a molecular weight of 176. In the acidic form of the phosphonate, each of the four hydrogens attached to the nitrogens is replaced by —CH₂PO₃H₂ to give the acid phosphonate a molecular weight of 552, of which P accounts for 124 (22.5%).

Comparative Example 1 A is an aminomethylene phosphonate mixture prepared using a mixture of amines having the formulas:
H₂NCH(CH₃)CH₂[OCH₂CH(CH₃)]₂NH₂
and
H₂NCH(CH₃)CH₂[OCH₂CH(CH₃)]₃NH₂
The mixture has an average molecular weight of 230. In the acidic form of the phosphonate, each of the four hydrogens attached to the nitrogens are replaced by:
—CH₂PO₃H₂
to give the acid phosphonate a molecular weight of 606, of which P accounts for 124 (20.5%).

Comparative Example 1 B is an aminomethylene phosphonate prepared using an amine mixture sold by Huntsman Chemical under the trade name “Amine C-12,” about 70 percent of the mixture having the formula:
H₂NCH₂CH₂OCH₂CH₂NH₂
It has a molecular weight of about 104. In the acidic form of the phosphonate, each of the four hydrogens attached to the nitrogens are replaced by:
—CH₂PO₃H₂
to give the acid phosphonate a molecular weight of about 480, of which P accounts for 124 (about 25.8%).

### Example 2

Example 1 is repeated substantially identically except that the comparative example is an aminomethylene phosphonate prepared using an amine having the formula:
H₂NCH₂CH₂OCH₂CH₂OCH₂CH₂NH₂
It has a molecular weight of 152. In the acidic form of the phosphonate, each of the four hydrogens attached to the nitrogens are replaced by:
—CH₂PO₃H₂

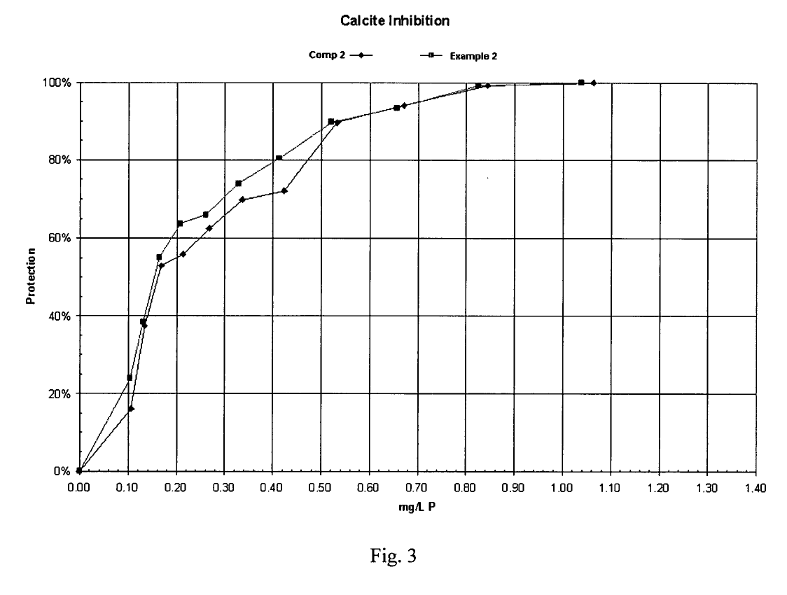

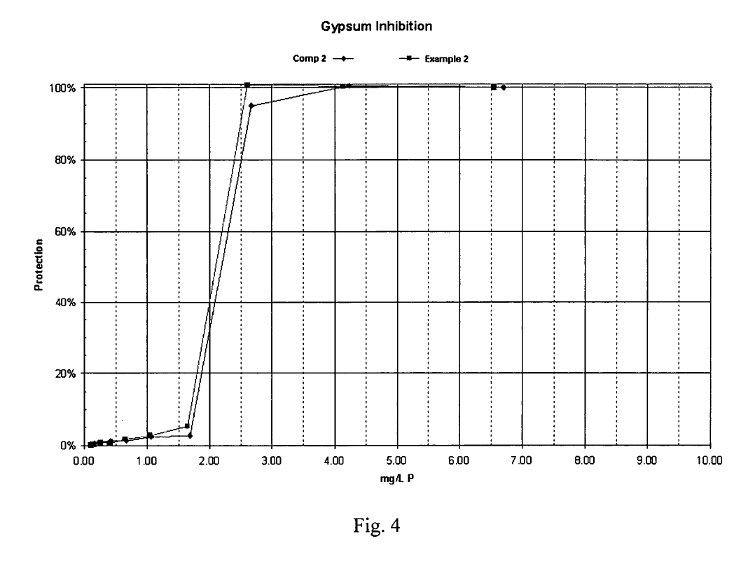

to give the acid phosphonate a molecular weight of 528, of which P accounts for 124 (23.5%). The test results are displayed in FIGS. 3 and 4.

TABLE 1
Amounts for 1.00 liter of Calcite Anion Brine Component

| Anion | mg/l | Salt Used | Grams Used |
|---|---|---|---|
| HCO₃⁻ | 1,115 | NaHCO₃ | 3.07 |
| Cl⁻ | 5,645 | NaCl | 7.68 |
| SO₄²⁻ | 81 | Na₂SO₄ | 0.24 |

TABLE 2
Amounts for 1.00 liter of Calcite Cation Brine Component

| Cation | mg/l | Salt Used | Grams Used |
|---|---|---|---|
| Ca²⁺ | 566 | CaCl₂.2H₂O | 4.15 |
| Na⁺ | 3,481 | NaCl. | 7.67 |

TABLE 3
Amounts for 1.00 liter of Gypsum Anion Brine Component

| Anion | mg/l | Salt Used | Grams Used |
|---|---|---|---|
| SO₄²⁻ | 10,000 | Na₂SO₄ | 29.58 |
| C₂H₃O₂⁻ | 1,000 | NaC₂H₃O₂ | 1.39 |
| Na⁺ | 5,176 | N/A | N/A |

TABLE 4
Amounts for 1.00 liter of Gypsum Cation Brine Component

| Cation | mg/l | Salt Used | Grams Used |
|---|---|---|---|
| Ca²⁺ | 5,000 | CaCl₂.2H₂O | 36.67 |
| C₂H₃O₂⁻ | 1,000 | NaC₂H₃O₂ | 1.38 |
| Cl⁻ | 8,845 | N/A | N/A |

What is claimed is:

1. A composition useful for inhibiting scale comprising: an aminomethylene phosphonate having the general formula: 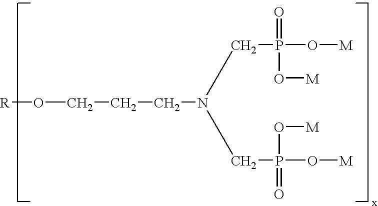
wherein x is an integer having a value of from 1 to 3, M is a hydrogen or a cation, and R is an atom or a hydrocarbyl having from 1 to 20 carbons.

2. The composition of claim 1 wherein R is selected from the group consisting of a methylene group; an ethylene glycol moiety having a general formula —CH₂—CH₂—; a propylene glycol moiety having a general formula —CH₂—CH₂—CH₂—; a diethylene glycol moiety having a general formula —CH₂—CH₂—O—CH₂—CH₂—; a cyclohexyl moiety having the general formula C₆H₈; a cyclohexyl moiety having the general formula C₆H₇; an alkyl ester moiety having the general formula CH₃—(CH₂)ₙCO₂— wherein n is an integer from 1 to 18; and mixtures thereof.

3. The composition of claim 2 wherein R is an ethylene glycol moiety having a general formula —CH₂—CH₂—.

4. The composition of claim 3 wherein x is 2 and M is a hydrogen.

5. The composition of claim 3 wherein x is 2 and M is a potassium atom.

6. The composition of claim 3 wherein x is 2 and M is a sodium atom.

7. A method for inhibiting scale formation in a system including moving or static water incorporating dissolved inorganic materials, the method comprising introducing into the system a scale inhibitor comprising an aminomethylene phosphonate having the general formula: 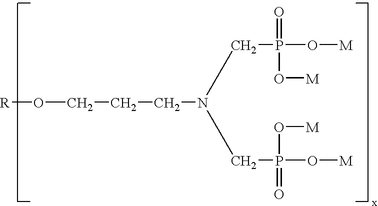
wherein x is an integer having a value of from 1 to 3, M is a hydrogen or a cation, and R is an atom or a hydrocarbyl having from 1 to 20 carbons.

8. The method of claim 7 wherein R is selected from the group consisting of a methylene group; an ethylene glycol moiety having a general formula —CH₂—CH₂—; a propylene glycol moiety having a general formula —CH₂—CH₂—CH₂—; a diethylene glycol moiety having a general formula —CH₂—CH₂—O—CH₂—CH₂—; a cyclohexyl moiety having the general formula C₆H₈; a cyclohexyl moiety having the general formula C₆H₇; an alkyl ester moiety having the general formula CH₃—(CH₂)ₙCO₂— wherein n is an integer from 1 to 18; and mixtures thereof.

9. The method of claim 8 wherein R is an ethylene glycol moiety having a general formula —CH₂—CH₂—.

10. The method of claim 9 wherein x is 2 and M is a hydrogen.

11. The method of claim 9 wherein x is 2 and M is a potassium atom.

12. The method of claim 9 wherein x is 2 and M is a sodium atom.

13. The method of claim 7 wherein the scale inhibitor is employed at a concentration of from about 0.01 ppm to about 10,000 ppm.

14. The method of claim 13 wherein the scale inhibitor is employed at a concentration of from about 0.1 ppm to about 1,000 ppm.

15. The method of claim 14 wherein the scale inhibitor is employed at a concentration of from about 1 ppm to about 100 ppm.

16. A composition of matter comprising an aminomethylene phosphonate having the general formula: 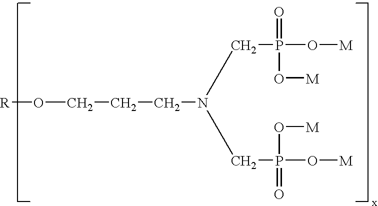
wherein x is an integer having a value of from 1 to 3, M is a hydrogen or a cation, and R is a hydrocarbyl having from 1 to 20 carbons.

17. The composition of matter of claim 16 wherein R is selected from the group consisting of a methylene group; an ethylene glycol moiety having a general formula —CH₂—CH₂—; a propylene glycol moiety having a general formula —CH₂—CH₂—CH₂—; a diethylene glycol moiety having a general formula —CH₂—CH₂—O—CH₂—CH₂—; a cyclohexyl moiety having the general formula C₆H₈; a cyclohexyl moiety having the general formula C₆H₇; an alkyl ester moiety having the general formula CH₃—(CH₂)ₙCO₂— wherein n is an integer from 1 to 18; and mixtures thereof.

18. The composition of matter of claim 17 wherein R is an ethylene glycol moiety having a general formula —CH₂—CH₂—.

19. The composition of matter of claim 18 wherein x is 2 and M is a hydrogen.

20. The composition of matter of claim 18 wherein x is 2 and M is a potassium atom.

21. The composition of matter of claim 19 wherein x is 2 and M is a sodium atom.

22. A composition useful for inhibiting corrosion or dispersing organics in an aqueous medium comprising the composition of matter of claim 16.
